(19) United States
(12) Patent Application Publication
(10) Pub. No.: US 2021/0142345 A1
(43) Pub. Date: May 13, 2021

(54) SYSTEM FOR IMPLEMENTING A REAL-TIME RESOURCE EVALUATION ENGINE

(71) Applicant: EVANS & ASSOCIATES CONSULTING GROUP, INC., Matthews, NC (US)

(72) Inventors: Phillip Edward Evans, Indian Trail, NC (US); Nathan Michael Bailey, Fort Mill, SC (US)

(73) Assignee: EVANS & ASSOCIATES CONSULTING GROUP, INC., Matthews, NC (US)

(21) Appl. No.: 17/081,324

(22) Filed: Oct. 27, 2020

Related U.S. Application Data
(60) Provisional application No. 62/933,806, filed on Nov. 11, 2019.

(51) Int. Cl. G06Q 30/02; G06Q 10/10; G06Q 50/16; G06F 16/28; G06N 20/00; G06K 9/20; G06K 9/62

(52) U.S. Cl. CPC G06Q 30/0205; G06Q 10/10; G06Q 30/0201; G06Q 50/16; G06K 9/6215; G06F 16/285; G06N 20/00; G06K 9/2081; G06K 9/6256; G06Q 30/0278

(57) ABSTRACT

Systems, computer program products, and methods are described herein for providing efficient retrieval of business valuation information. The present invention is configured to receive, via a user device, information associated with a first business; retrieve from a business classification database, a business classification code; automatically retrieve, from a valuation database, one or more business names; determine a similarity metric between the first business and each of the one or more business names; retrieve, from the valuation database, one or more business valuations associated with the one or more business names; initiate a dashboard report script, wherein the dashboard report script is configured to display the one or more business names with corresponding information, including the one or more business valuations associated with the one or more business names.

### PRIORITY CLAIM

This application claims priority to U.S. Provisional Application Ser. No. 62/933,806, entitled “BUSINESS VALUATION TOOL”, filed Nov. 11, 2019, which is incorporated herein by reference in its entirety.

### FIELD OF THE INVENTION

The present invention embraces a system for implementing a real-time resource evaluation engine.

### BACKGROUND

Typically, when a business valuation is to be determined, users tend to determine an approximate value of the business based on the valuation of comparable businesses. However, with many businesses having same or similar names across many business types, identifying comparable businesses to determine an average valuation requires a more efficient strategy.

There is a need for a tool capable of providing comparable business equipment values based on a business classification database, such as the North American Industry Classification System (NAICS) code, using search criterial including business/industry type, business range/type, and value range.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for implementing a real-time resource evaluation engine is presented. The system comprising: at least one non-transitory storage device; and at least one processing device coupled to the at least one non-transitory storage device, wherein the at least one processing device is configured to: electronically receive, via a user device, a first user input, wherein the first user input comprises information associated with a first business; retrieve from a business classification database, a business classification code based on at least the first user input; automatically retrieve, from a valuation database, one or more business names based on at least the business classification code; determine a similarity metric between the first business and each of the one or more business names based on at least the first user input; retrieve, from the valuation database, one or more business valuations associated with the one or more business names; and initiate a dashboard report script, wherein the dashboard report script is configured to generate a graphical interface for display on the user device, wherein the graphical interface comprises the one or more business names, the one or more business valuations associated with the one or more business names, the business classification code associated with the one or more business names, and the similarity metric between the first business and the one or more business names.

In some embodiments, the at least one processing device is further configured to: electronically receive, via the first user device, the first user input, wherein receiving further comprises receiving one or more images of the first business captured using an image capturing device associated with the user device.

In some embodiments, the at least one processing device is further configured to: electronically receive, via the first device, the first user input, wherein the first user input comprises at least location-related information for the first business; and electronically retrieve, from a mapping system database, one or more sequential static images of one or more structures associated with the location-related information for the first business.

In some embodiments, the at least one processing device is further configured to: initiate one or more machine learning algorithms on the one or more images of the first business and/or the one or more sequential static images of the one or more structures associated with the location-related information for the first business; retrieve, using the one or more machine learning algorithms, one or more identifying features from the one or more images of the first business and/or the one or more sequential static images of the one or more structures; and generate a machine learning model based on at least the one or more identifying features.

In some embodiments, the at least one processing device is further configured to: electronically receive, from the user device, a geographic boundary associated with the first business; determine one or more businesses that are within the geographic boundary associated with the first business; retrieve, from a real estate database, one or more images associated with one or more structures of the one or more business names; determine, using the machine learning model, a match between the one or more images associated with the one or more structures of the one or more business names, and one or more images of the first business and/or the one or more sequential static images of the one or more structures associated with the location-related information for the first business; and generate the similarity metric between the first business and the one or more business names based on at least the match.

In some embodiments, the at least one processing device is further configured to: initiate a content based image retrieval protocol on the one or more sequential static images of the one or more structures and/or the one or more images of the first business; retrieve, using the content based image retrieval protocol, one or more images of one or more structures that are similar to the one or more sequential static images of the one or more structures and/or the one or more images of the first business; and determine the one or more business names associated with the one or more images of the one or more structures.

In some embodiments, the at least one processing device is further configured to: electronically receive, via the user device, a second user input, wherein the second user input comprises a business valuation range; and retrieve, from the valuation database, the one or more business valuations associated with the one or more business names within the business valuation range.

In some embodiments, the valuation database comprises information associated with the businesses, wherein the information associated with the businesses comprises at least a business name, a business personal property (BPP) value, monitoring and evaluation value, assessment year, location, and/or an associated business classification code.

In another aspect, a computer program product for implementing a real-time resource evaluation engine is presented. The computer program product comprising a non-transitory computer-readable medium comprising code causing a first apparatus to: electronically receive, via a user device, a first user input, wherein the first user input comprises information associated with a first business; retrieve from a business classification database, a business classification code based on at least the first user input; automatically retrieve, from a valuation database, one or more business names based on at least the business classification code; determine a similarity metric between the first business and each of the one or more business names based on at least the first user input; retrieve, from the valuation database, one or more business valuations associated with the one or more business names; and initiate a dashboard report script, wherein the dashboard report script is configured to generate a graphical interface for display on the user device, wherein the graphical interface comprises the one or more business names, the one or more business valuations associated with the one or more business names, the business classification code associated with the one or more business names, and the similarity metric between the first business and the one or more business names.

In yet another aspect, a method for implementing a real-time resource evaluation engine is presented. The method comprising: electronically receiving, via a user device, a first user input, wherein the first user input comprises information associated with a first business; retrieving from a business classification database, a business classification code based on at least the first user input; automatically retrieving, from a valuation database, one or more business names based on at least the business classification code; determining a similarity metric between the first business and each of the one or more business names based on at least the first user input; retrieving, from the valuation database, one or more business valuations associated with the one or more business names; and initiating a dashboard report script, wherein the dashboard report script is configured to generate a graphical interface for display on the user device, wherein the graphical interface comprises the one or more business names, the one or more business valuations associated with the one or more business names, the business classification code associated with the one or more business names, and the similarity metric between the first business and the one or more business names.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 presents an exemplary block diagram of the system environment for implementing a real-time resource evaluation engine, in accordance with an embodiment of the invention;

FIG. 2 illustrates a process flow for implementing a real-time resource evaluation engine, in accordance with an embodiment of the invention;

FIG. 3 illustrates an exemplary user interface for implementing a real-time resource evaluation engine, in accordance with an embodiment of the invention; and

FIGS. 4-5 illustrate an exemplary dashboard interface for implementing a real-time resource evaluation engine, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “business” may be any institution employing information technology resources and particularly technology infrastructure configured for processing large amounts of data. Typically, these data can be related to the people who work for the business, its products or services, the customers or any other aspect of the operations of the business. As such, the business may be any institution, group, association, financial institution, establishment, company, union, authority or the like, employing information technology resources for processing large amounts of data.

As used herein, a “user” may be an individual attempting to determine the value of the business. In some embodiments, a user may be any individual, business or system who has an existing relationship with the business. In some other embodiments, a user may be an individual, business or system who does not have an existing relationship with the business.

As used herein, a “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, an “protocol” may refer to core elements of a computer program, or part of a computer program that serves as a foundation for a larger piece of software and drives the functionality of the software. A protocol may be self-contained, but externally-controllable code that encapsulates powerful logic designed to perform or execute a specific type of function. In one aspect, a protocol may be underlying source code that establishes file hierarchy, input and output methods, and how a specific part of a computer program interacts or communicates with other software and/or hardware. The specific components of a protocol may vary based on the needs of the specific computer program as part of the larger piece of software. In some embodiments, a protocol may be configured to retrieve resources created in other computer programs, which may then be ported into the protocol for use during specific operational aspects of the protocol. A protocol may be configurable to be implemented within any general purpose computing system. In doing so, the protocol may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

Typically, when a business valuation is to be determined, users tend to determine an approximate value of the business based on the valuation of comparable businesses. However, with many businesses having same or similar names across many business types, identifying comparable businesses to determine an average valuation requires a more efficient strategy. The present invention provides the functional benefit of providing a cloud-based online tool capable of providing comparable business valuation based on a business classification database such as the North American Industry Classification System (NAICS). In this regard, the system of the present invention enables a user to narrow the search criteria by using various options, including industry type, business range/type, and value range, in combination with the business classification code for more efficient data retrieval.

FIG. 1 presents an exemplary block diagram of the system environment for implementing a real-time resource evaluation engine 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute one or more applications stored thereon. The one or more applications may be configured to communicate with the system 130, perform a transaction, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, personal digital assistants, servers, blade servers, mainframes, and other appropriate computers. The user input system 140 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application and allows memory reuse for better utilization of the memory resources when the data sizes are large.

The high-speed interface 1408 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140 or may also store applications or other information therein. In some embodiments, expansion memory may include instructions to carry out or supplement the processes described above and may include secure information also. For example, expansion memory may be provided as a security module for user input system 140 and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation—and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

FIG. 2 illustrates a process flow for implementing a real-time resource evaluation engine 200, in accordance with an embodiment of the invention. As shown in block 202, the process flow includes receiving, via a user interface displayed on a user device, a first user input. In some embodiments, the first user input may include information associated with a first business. In one aspect, the information associated with the first business may include a business type. Typically, each business is classified based on the type of primary business activity, economic activity, or process of production. A business, while generally a single physical location, can have administratively distinct operations at a single location, and be considered as multiple distinct businesses. In another aspect, the information associated with the first business may include one or more images of the first business. In this regard, the system may be configured to electronically receive one or more images of the first business captured using an image capturing device associated with the user device, such as an onboard embedded camera. In yet another aspect, the information associated with the first business may include location-related information for the first business, such as an address.

Next, as shown in block 204, the process flow includes retrieving from a business classification database, a business classification code based on at least the first user input. In some embodiments, the business classification database may be a NAICS database, Standard Industrial Classification (SIC) Code database, and/or a combination of one or more similar databases. Typically, the business classification database may include a list of businesses that are classified based on the type of economic activity. For example, the NAICS numbering system employs a five or six-digit code at the most detailed business/industry level, used by government and businesses in Canada, Mexico, and the United States of America. The first five digits are generally (although not always strictly) the same in all three countries. The first two digits designate the largest business sector, the third digit designates the subsector, the fourth digit designates the business group, the fifth digit designates the NAICS businesses, and the sixth digit designates the national businesses. Accordingly, each business is classified into a business type and assigned a business classification code, such as a NAICS code.

Next, as shown in block 206, the process flow includes automatically retrieving, from a valuation database, one or more business names based on at least the business classification code. In some embodiments, the valuation database may include information associated with the businesses based on certified public tax values. In some embodiments, the information associated with the businesses may include a business name, a business personal property (BPP) value, monitoring and evaluation value, assessment year, location by state and region, the business classification code, and/or the like.

Next, as shown in block 208, the process flow includes determining a similarity metric between the first business and each of the one or more business names based on at least the first user input. In cases where the first user input includes location-related information, the system may be configured to electronically retrieve, from a mapping system database, one or more sequential static images of one or more structures (such as buildings) associated with the location-related information for the first business. These sequentially static images of the structures can then be used to identify other similar business with the same structural footprint.

In some embodiments, the system may be configured to initiate one or more machine learning algorithms on the one or more images of the first business and/or the one or more sequential static images of the one or more structures associated with the location-related information for the first business. In this regard, the system may be configured to implement any of the following applicable machine learning algorithms either singly or in combination: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable machine learning model type. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system. Further, any suitable model (e.g., machine learning, non-machine learning, etc.) can be used in generating data relevant to the system.

In response, the system may be configured to retrieve, using the one or more machine learning algorithms, one or more identifying features from the one or more images of the first business and/or the one or more sequential static images of the one or more structures. In one aspect, the identifying features may include overall visual aspects of each structure. These visual aspects may include general aspects of its setting, the shape of the structure, its roof and roof features, such as chimneys or cupolas, the various projections on the structure, such as porches or bay windows, the recesses or voids in a structure, such as open galleries, arcades, or recessed balconies, the openings for windows and doorways, the various exterior materials that contribute to the structure's character and/or the like. In another aspect, the identifying features may include visual character at close range. These visual characters may include surface qualities of the materials, such as their color and texture, or surface evidence of craftsmanship, age, or the juxtaposition of materials that are contrastingly different in their color and texture. In yet another aspect, the identifying features may be interior spaces that are identifiable.

In response to retrieving the identifying features, the system may be configured to generate, using the one or more machine learning algorithms, a machine learning model based on at least the one or more identifying features. In some embodiments, a machine learning model is the output of the machine learning algorithm run on data (identifying features of the structures). The model represents what was learned by the machine learning algorithm. In one aspect, the machine learning model represents the rules, numbers, and any other algorithm-specific data structures required to for classification. For example, a linear regression algorithm results in a model comprised of a vector of coefficients with specific values, a decision tree algorithm results in a model comprised of a tree of if-then statements with specific values, a neural network/backpropagation/gradient descent algorithms together result in a model comprised of a graph structure with vectors or matrices of weights with specific values, and/or the like.

In some embodiments, the system may be configured to electronically receive, from the user device, a geographic boundary associated with the first business. In some embodiments, when identifying comparable businesses to determine a valuation for a business, users may restrict the geographic landscape to a predetermined boundary. This is because comparable businesses that are in close proximity to each other may be within a smaller range of valuation than comparable businesses that are farther away from each other.

In response, the system may be configured to determine one or more businesses that are within the geographic boundary associated with the first business. In response, the system may be configured to retrieve, from a real estate database, one or more images associated with one or more structures of the one or more business names. Most counties within the United States maintain a publicly accessible real estate database where users can search for information associated with a business, such as business name, owner name, images of structures associated with the business, or the like. A number of other real estate databases that are not maintained by the counties are also available for users free of charge. These real estate databases may be queried for information based on a specific geographic area. By confining the query to the geographic boundary, the system may be configured to identify businesses within the geographic boundary.

In some embodiments, the system may be configured to retrieve one or more images associated with the one or more structures of the one or more business names from the real estate database. In response, the system may be configured to extract identifying features that are similar to the identifying features extracted from the one or more images of the first business and/or the one or more sequential static images of the one or more structures associated with the location-related information for the first business. In this way, when the machine learning model may classify (match) the images based on the extracted identifying features.

In response, the system may be configured to determine, using the machine learning model, a match between the one or more images associated with the one or more structures of the one or more business names, and one or more images of the first business and/or the one or more sequential static images of the one or more structures associated with the location-related information for the first business. In one aspect, the machine learning model may be used to classify the images associated with the one or more structures of the one or more business names into one or more classes. For instance, the classes for classifying the images may include, images that are similar to the first business and images that are different from the first business. In some embodiments, in response to determining the match (classifying the images), the system may be configured to generate the similarity metric between the first business and the one or more business names based on at least the match. Based on the similarity metric, the user may be able to identify and select the one or more businesses that are comparable to the first business to determine its value.

In some embodiments, the system may be configured to initiate a content based image retrieval protocol (e.g., a reverse image search) on the one or more sequential static images of the one or more structures and/or the one or more images of the first business. In response, the system may be configured to retrieve, using the content based image retrieval protocol, one or more images of one or more structures that are similar to the one or more sequential static images of the one or more structures and/or the one or more images of the first business. In response, the system may be configured to determine the one or more business names associated with the one or more images of the one or more structures. In one aspect, the system may be configured to confine the reverse image search based on the geographic boundary received from the user.

In some embodiments, the system may be configured to receive, via the user device, a second user input, wherein the second user input comprises a business valuation range. In some embodiments, the business value of the business may refer to the entire value of the business: the total sum of all tangible and intangible elements. Examples of tangible elements includes, but is not limited to, monetary assets, stockholder's equity, fixtures, and utility. Examples of intangible elements include brand, recognition, good will, public benefit, and trademarks. In other words, business value of the business covers both the monetary and non-monetary values of a firm. Business valuations may be determined based on at least revenue, profitability, market share, brand recognition, customer loyalty, customer retention, share of wallet, cross-selling ratio, campaign response rate, customer satisfaction, and/or the like. By defining a range for business valuation, the user may be able to narrow the retrieved business names to relevant comparable businesses.

Next, as shown in block 210, the process flow includes retrieving from the valuation database, one or more business valuations associated with the one or more business names. In some embodiments, in addition to retrieving the business valuations and the business names, the system may be configured to retrieve average and median business values, distribution and trends in business values, and/or the like.

Next, as shown in block 212, the process flow includes initiating a dashboard report script to generate a report comprising the one or more business names, the one or more business valuations associated with the one or more business names, the business classification code associated with the one or more business names, and the similarity metric between the first business and the one or more business names. In some embodiments, the system may be configured to enable the user to upload details including contact information, statistical data, images of the business, business owner information, situs address, and/or the like.

In some embodiments, the system may be configured to generate the report for distribution to one or more third party entities. Each third party entity may require the generated report in a specific format. Accordingly, in one aspect, the system may be configured to determine a reporting template associated with each third party entity. In some embodiments, the reporting template may be provided by each third party. In some other embodiments, the reporting template may be generated by the system based on previously generated reports and user input. In response to determining the reporting template, the system may be configured to generate the report in accordance with each reporting template. Accordingly, the dashboard reporting script may be configured to allow the user to select which of the third party entities require the generated information (such as the one or more business names, the one or more business valuations associated with the one or more business names, the business classification code associated with the one or more business names, and the similarity metric between the first business and the one or more business names). In response to the user selection, the system may be configured to identify the corresponding reporting template for the third party entity. Once retrieved, the dashboard reporting script may be configured to generate the report based on the reporting template.

FIG. 3 illustrates an exemplary user interface for providing efficient retrieval of business valuation information 300, in accordance with an embodiment of the invention. As described herein, the user may enter a business type under the NAICS industry type field 304 to retrieve the NAICS code, which is displayed at 304. In addition to retrieving the NAICS code, the system may be configured to automatically populate the business description at 308. In some embodiments, the system may be configured to enable the user to narrow the search results further by entering a business name 302, a minimum value 310, and/or a maximum value 312.

FIGS. 4-5 illustrate an exemplary dashboard interface for providing efficient retrieval of business valuation information 400-500, in accordance with an embodiment of the invention. As shown in FIG. 4, the dashboard interface includes a list of businesses 404 in response to the user executing a search, as described herein. In addition, the dashboard interface may include one or more business valuations associated with the business names and any information retrieved from the valuation database 404. In some embodiments, the dashboard interface 400 includes a graphical presentation of the business names and the corresponding business values 402. In one aspect, the graphical representation may include, but is not limited to a pareto diagram, a pie chart, a histogram, a stem and leaf plot, a dot plot, a scatter plot, a time-series graph, and/or the like.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for implementing a real-time resource evaluation engine, the system comprising:
at least one non-transitory storage device; and
at least one processing device coupled to the at least one non-transitory storage device, wherein the at least one processing device is configured to:
electronically receive, via a user device, a first user input, wherein the first user input comprises information associated with a first business;
retrieve from a business classification database, a business classification code based on at least the first user input;
automatically retrieve, from a valuation database, one or more business names based on at least the business classification code;
determine a similarity metric between the first business and each of the one or more business names based on at least the first user input;
retrieve, from the valuation database, one or more business valuations associated with the one or more business names; and
initiate a dashboard report script, wherein the dashboard report script is configured to generate a graphical interface for display on the user device, wherein the graphical interface comprises the one or more business names, the one or more business valuations associated with the one or more business names, the business classification code associated with the one or more business names, and the similarity metric between the first business and the one or more business names.

2. The system of claim 1, wherein the at least one processing device is further configured to:
electronically receive, via the first user device, the first user input, wherein receiving further comprises receiving one or more images of the first business captured using an image capturing device associated with the user device.

3. The system of claim 1, wherein the at least one processing device is further configured to:
electronically receive, via the first device, the first user input, wherein the first user input comprises at least location-related information for the first business; and
electronically retrieve, from a mapping system database, one or more sequential static images of one or more structures associated with the location-related information for the first business.

4. The system of claim 3, wherein the at least one processing device is further configured to:
initiate one or more machine learning algorithms on the one or more images of the first business and/or the one or more sequential static images of the one or more structures associated with the location-related information for the first business;
retrieve, using the one or more machine learning algorithms, one or more identifying features from the one or more images of the first business and/or the one or more sequential static images of the one or more structures; and
generate a machine learning model based on at least the one or more identifying features.

5. The system of claim 4, wherein the at least one processing device is further configured to:
electronically receive, from the user device, a geographic boundary associated with the first business;
determine one or more businesses that are within the geographic boundary associated with the first business;
retrieve, from a real estate database, one or more images associated with one or more structures of the one or more business names;
determine, using the machine learning model, a match between the one or more images associated with the one or more structures of the one or more business names, and one or more images of the first business and/or the one or more sequential static images of the one or more structures associated with the location-related information for the first business; and
generate the similarity metric between the first business and the one or more business names based on at least the match.

6. The system of claim 3, wherein the at least one processing device is further configured to:
initiate a content based image retrieval protocol on the one or more sequential static images of the one or more structures and/or the one or more images of the first business;
retrieve, using the content based image retrieval protocol, one or more images of one or more structures that are similar to the one or more sequential static images of the one or more structures and/or the one or more images of the first business; and
determine the one or more business names associated with the one or more images of the one or more structures.

7. The system of claim 1, wherein the at least one processing device is further configured to:
electronically receive, via the user device, a second user input, wherein the second user input comprises a business valuation range; and
retrieve, from the valuation database, the one or more business valuations associated with the one or more business names within the business valuation range.

8. The system of claim 1, wherein the valuation database comprises information associated with the businesses, wherein the information associated with the businesses comprises at least a business name, a business personal property (BPP) value, monitoring and evaluation value, assessment year, location, and/or an associated business classification code.

9. A computer program product for implementing a real-time resource evaluation engine, the computer program product comprising a non-transitory computer-readable medium comprising code causing a first apparatus to:
electronically receive, via a user device, a first user input, wherein the first user input comprises information associated with a first business;
retrieve from a business classification database, a business classification code based on at least the first user input;
automatically retrieve, from a valuation database, one or more business names based on at least the business classification code;
determine a similarity metric between the first business and each of the one or more business names based on at least the first user input;
retrieve, from the valuation database, one or more business valuations associated with the one or more business names; and
initiate a dashboard report script, wherein the dashboard report script is configured to generate a graphical interface for display on the user device, wherein the graphical interface comprises the one or more business names, the one or more business valuations associated with the one or more business names, the business classification code associated with the one or more business names, and the similarity metric between the first business and the one or more business names.

10. The computer program product of claim 9, wherein the first apparatus is further configured to:
electronically receive, via the first user device, the first user input, wherein receiving further comprises receiving one or more images of the first business captured using an image capturing device associated with the user device.

11. The computer program product of claim 9, wherein the first apparatus is further configured to:
electronically receive, via the first device, the first user input, wherein the first user input comprises at least location-related information for the first business; and
electronically retrieve, from a mapping system database, one or more sequential static images of one or more structures associated with the location-related information for the first business.

12. The computer program product of claim 11, wherein the first apparatus is further configured to:
initiate one or more machine learning algorithms on the one or more images of the first business and/or the one or more sequential static images of the one or more structures associated with the location-related information for the first business;
retrieve, using the one or more machine learning algorithms, one or more identifying features from the one or more images of the first business and/or the one or more sequential static images of the one or more structures; and
generate a machine learning model based on at least the one or more identifying features.

13. The computer program product of claim 12, wherein the first apparatus is further configured to:
electronically receive, from the user device, a geographic boundary associated with the first business;
determine one or more businesses that are within the geographic boundary associated with the first business;
retrieve, from a real estate database, one or more images associated with one or more structures of the one or more business names;
determine, using the machine learning model, a match between the one or more images associated with the one or more structures of the one or more business names, and one or more images of the first business and/or the one or more sequential static images of the one or more structures associated with the location-related information for the first business; and
generate the similarity metric between the first business and the one or more business names based on at least the match.

14. The computer program product of claim 11, wherein the first apparatus is further configured to:
initiate a content based image retrieval protocol on the one or more sequential static images of the one or more structures and/or the one or more images of the first business;
retrieve, using the content based image retrieval protocol, one or more images of one or more structures that are similar to the one or more sequential static images of the one or more structures and/or the one or more images of the first business; and
determine the one or more business names associated with the one or more images of the one or more structures.

15. The computer program product of claim 9, wherein the first apparatus is further configured to:
electronically receive, via the user device, a second user input, wherein the second user input comprises a business valuation range; and
retrieve, from the valuation database, the one or more business valuations associated with the one or more business names within the business valuation range.

16. The computer program product of claim 9, wherein the valuation database comprises information associated with the businesses, wherein the information associated with the businesses comprises at least a business name, a business personal property (BPP) value, monitoring and evaluation value, assessment year, location, and/or an associated business classification code.

17. A method for implementing a real-time resource evaluation engine, the method comprising:
electronically receiving, via a user device, a first user input, wherein the first user input comprises information associated with a first business;
retrieving from a business classification database, a business classification code based on at least the first user input;
automatically retrieving, from a valuation database, one or more business names based on at least the business classification code;
determining a similarity metric between the first business and each of the one or more business names based on at least the first user input;
retrieving, from the valuation database, one or more business valuations associated with the one or more business names; and
initiating a dashboard report script, wherein the dashboard report script is configured to generate a graphical interface for display on the user device, wherein the graphical interface comprises the one or more business names, the one or more business valuations associated with the one or more business names, the business classification code associated with the one or more business names, and the similarity metric between the first business and the one or more business names.

18. The method of claim 17, wherein the method further comprises:
electronically receiving, via the first user device, the first user input, wherein receiving further comprises receiving one or more images of the first business captured using an image capturing device associated with the user device.

19. The method of claim 17, wherein the method further comprises:
electronically receiving, via the first device, the first user input, wherein the first user input comprises at least location-related information for the first business; and
electronically retrieving, from a mapping system database, one or more sequential static images of one or more structures associated with the location-related information for the first business.

20. The system of claim 19, wherein the method further comprises:
initiating one or more machine learning algorithms on the one or more images of the first business and/or the one or more sequential static images of the one or more structures associated with the location-related information for the first business;
retrieving, using the one or more machine learning algorithms, one or more identifying features from the one or more images of the first business and/or the one or more sequential static images of the one or more structures; and
generating a machine learning model based on at least the one or more identifying features.
